(19) United States
(12) Patent Application Publication
(10) Pub. No.: US 2011/0247970 A1
(43) Pub. Date: Oct. 13, 2011

(54) Portable Pump And Filter Assembly For Use In Pools, Spas And Open Bodies Of Water

(76) Inventor: Michael Evingham, Laguna Niguel, CA (US)

(21) Appl. No.: 13/080,484

(22) Filed: Apr. 5, 2011

Related U.S. Application Data
(60) Provisional application No. 61/322,280, filed on Apr. 8, 2010.

(51) Int. Cl. B01D 35/26; B01D 35/05; B01D 35/02; C02F 1/00

(52) U.S. Cl. 210/85; 210/416.1; 210/242.1; 210/251; 210/232; 210/323.1

(57) ABSTRACT

The present invention is directed to a portable submersible pump and filter assembly for direct filtration of a body of water without the need for intake or discharge hoses or assemblies. The present invention is further directed to a pump and filter assembly that can be positioned at any depth within the water being filtered and can be easily removed after the desired filtration is complete. The present invention is further directed to a solar powered portable pump and filter assembly that operates while floating on fluid being filtered. The present invention is further directed to a highly efficient portable pump and filter assembly that is adapted to be directly coupled to and powered by various power sources including direct current and green energy supplies such as solar or wind power.

### CROSS-REFERENCE TO RELATED APPLICATION

The present application claims priority from and is entitled to the benefit of U.S. Provisional Patent Application Ser. No. 61/322,280 entitled “Portable And Submersible Pump And Filter Assembly For Use In Pools, Spas And Generally Any Open Body Of Water,” filed on Apr. 8, 2010, by inventor Michael Evingham, which is hereby incorporated by reference in its entirety into this disclosure.

### BACKGROUND

1. Field of the Invention

The present invention relates generally to submersible pump and filter assemblies and more specifically to submersible pump and filter assemblies for filtering pools, spas and generally any body of water or water based fluid.

2. Description of the Background Art

Typically and conventionally, pools and spas are cleaned by way of the water moving into a fixed cleaning inlet or skimmer and through a filter or trap assembly and discharged back into the main body of water. A pump is used to move this water. Typically, the pump is located in a location away from the pool or spa.

A disadvantage of conventional water cleaning systems for pools and spas and even larger fountains and ponds, is the costs and planning associated with the design, purchase and installation of such systems. Further to this problem is the high cost to operate and maintain these systems, including the high electric demand of the pumps required to move water through the complex plumbing systems. Moreover, the complexity of operating and maintaining these conventional cleaning systems further adds to the problems associated with conventional filtering systems.

Another problem with conventional systems for cleaning and filtering pool and spa and even larger fountain and pond water is having the space to place such pump and filtration equipment as well the noise generated by such equipment.

Another problem with conventional water filtration systems for pools, spas and even larger fountains and ponds is the dangers conditions created by such systems, including the dangers associated with high voltage electricity, high water pressure, high suction through water inlets, and even water leaks in the plumbing to and from the cleaning equipment.

Another problem is the lack of equipment and/or methods to efficiently clean water in fountains, ponds, and other smaller bodies of water, while being able to remove the water cleaning assembly after such cleaning. In some cases, simply provided the necessary electricity is a problem, burden or safety concern.

### SUMMARY

The present invention is directed to a novel water filtration system and method that is adapted to work with novel submersible support assembly to create a highly efficient portable and submersible water filtration system that could easily be placed into the body of water and left to filter the water. The present filtration system utilizes high efficiency components and direct flow paths without conventional hoses and plumbing to take advantage of various low voltage, battery and green energy supplies

Specifically, the present invention is directed to a submersible pump and filter assembly for filtering a body of water. The pump and filter assembly includes a submersible electric pump having an inlet and a discharge. The pump is adapted to push water from its inlet port and out through its discharge port. A tubular passageway couples a filter assembly to the inlet of the pump. The filter includes a filtration surface and a filter outlet and is designed to filter water passing through the filtration surface and out through the filter outlet. The tubular fluid passageway couples the pump inlet to the filter discharge such that the pump draws water through the filter surface and out through the pump discharge. A support assembly is coupled to the tubular passageway and is adapted to support the pump and filter assembly on a generally flat surface at the base of the body of water being filtered such that the filter is elevated above such bottom.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1A shows a perspective view of an embodiment of the present invention.

FIG. 1B shows a perspective view of an embodiment of the present invention with the pump assembly detached from the filter assembly.

FIG. 2 shows a perspective view of an alternative embodiment of the present invention having a support base.

FIG. 3 shows a perspective view of an embodiment of the present invention having multiple filter assemblies.

FIG. 4 shows a perspective view of an embodiment of the present invention having multiple filter assemblies in a circular arrangement around a single pump assembly.

FIG. 5A shows a perspective view of an embodiment the present invention utilizing an inline style pump system.

FIG. 5B shows a perspective view of an embodiment of the present invention utilizing an inline pump assembly with the pump assembly and the filter assembly removed from the support and manifold assembly.

FIG. 6A shows a cut away view of an embodiment of the present invention positioned at the bottom of a body of water.

FIG. 6B shows a cut away view of an embodiment of the present invention utilizing a green energy source.

FIG. 6C shows a cut away view of an embodiment of the present invention utilizing a floating solar power supply.

FIG. 7 shows a cut away view of an embodiment of the present invention positioned above the bottom of the body of water.

FIG. 8A shows a top cut away view of an embodiment of the present invention having a battery power supply and additional features.

FIG. 8B shows a top cut away view of an embodiment of the present invention having a battery power supply and additional features

FIG. 9A shows a side cut away view of an embodiment of the present invention having a battery power supply located at the bottom of a pool.

FIG. 9B shows a side cut away view of an embodiment of the present invention having a battery power supply and supported above the bottom of a pool.

FIG. 10 shows a side cut away view of an embodiment of the present invention having an integral solar panel and shown operating at the surface of the pool.

FIG. 11A shows a perspective view of an embodiment of the present invention utilizing an integral float assembly and solar power supply.

FIG. 11B shows an exploded perspective view of the embodiment of the present invention shown in FIG. 11A.

FIG. 11C shows a perspective view of the embodiment of the present invention shown in FIG. 11A, from the underside and exposing multiple filters.

FIG. 11D shows an alternative perspective view of the embodiment of the present invention shown in FIG. 11A.

FIG. 12 shows a side perspective view of an embodiment of the float and manifold assembly of the present invention.

FIG. 13 shows a top perspective view of an embodiment of the float and manifold assembly of the present invention.

### DETAILED DESCRIPTION OF THE INVENTION

The present invention is directed to an improved system and method of filtering water and more particularly at an improved system and method of filtering water associated with pools, spas, fountains, ponds, wells, tanks or any other body of water that is generally accessible from the surface. The present filtration system utilizes high efficiency components that are generally directly coupled with nonrestrictive flow paths and larger filtration surfaces so as to avoid the need of high powered pumps, conventional hoses and plumbing. Moreover, the high efficiency and low power draw allows the novel pump and filter assembly to further take advantage of various low voltage, battery and green energy supplies, thereby increasing efficiency, utility and safety as well as allowing for remote operation. The high efficiency, small size, low cost of manufacture and operation make the present invention suitable for huge variety of filtering tasks above and beyond pool and spa water cleaning, including but not limited to cleaning of fountains, ponds and wells as well as dirty water supplies in remote and poor areas and for emergency applications.

In use, the pump and filter assembly of the present invention is simply placed into a pool, spa, fountain, well or other body of water to be filtered and turned on. After a designated period of operating time or filtration, the pump and filter assembly may simply be removed from the now filtered body of water. A timer may be provided to ensure proper filtration is achieved without over filtering or operating more than desired.

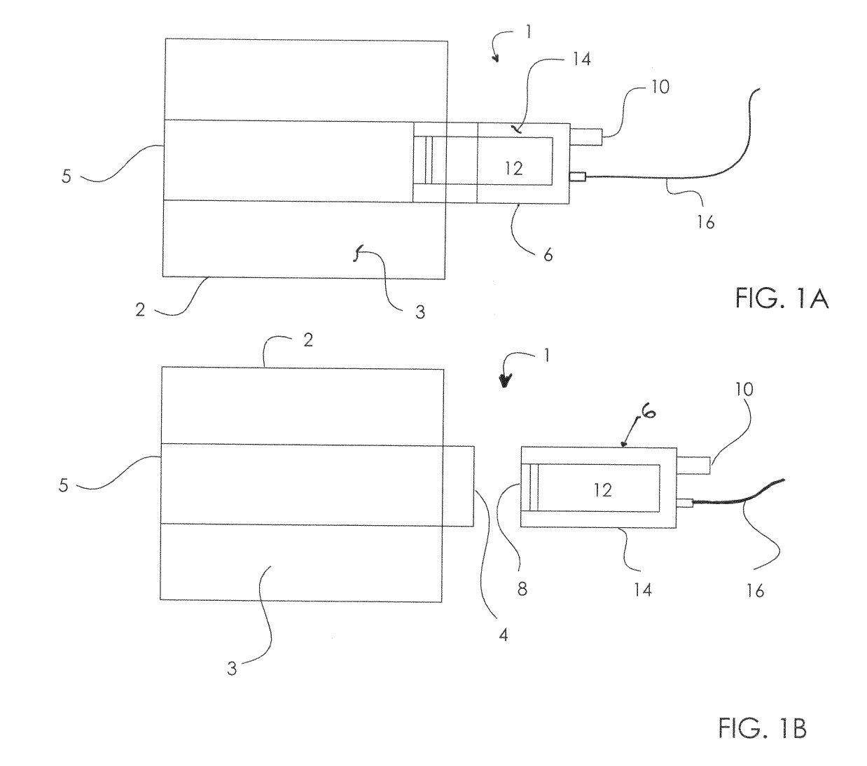

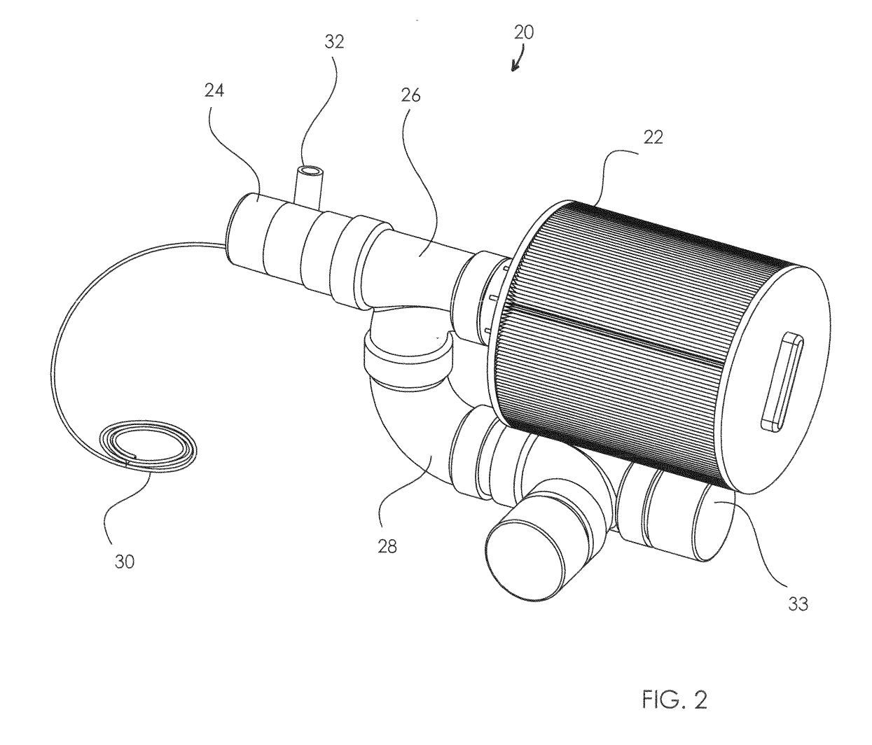

Referring now to FIGS. 1A and 1B, the present invention provides a submersible pump and filter assembly 1 adapted to be fully submerged in a body of water and to filter such water. The pump and filter assembly 1 includes a filter assembly 2 that has an inlet or filtration surface 3 and an outlet port or discharge 4. The filter assembly 2 may also include a second outlet port 5 as shown with end cap 5. Preferably any second outlet port 5 is capped, plugged or nonexistent. In a preferred embodiment, the filter assembly 2 is a readily available surface filter, such as a cylindrical cartridge filter available from Pleatco, LLC of Glen Cove, N.Y. Such filters are readily available at stores that carry pool and spa supplies.

The pump and filter assembly 1 also includes a pump 6 for moving large volumes of water through the filter assembly 2. The pump 6 includes an inlet port 8 and a discharge 10. An electric pump motor 12 is supported within a housing 14 and is used to actual move the fluid from the inlet port 8 and out through the discharge 10. A submersible electric connection 16 electrically couples the pump motor 12 with an electrical power supply (not shown). In a preferred embodiment, the pump 6 is a readily available submersible pump, such as inline submersible pumps available from ITT Corporation of White Plains, N.Y. and readily available at many stores that carry pumps, boating and rv supplies and often sold under the names Rule or Laing. A preferred pump 6, however, such as the Laing D5 850N is not currently watertight and should be sealed, such as coated with a polymer sealant, to prevent water intrusion. Similarly, all electrical connections and components should be adapted for submersion in the water to be filtered and generally watertight.

For smaller bodies of fluid or lower filtration requirements, smaller pumps may be used. Similarly, larger pumps are preferred for larger volumes or higher filtration needs. In a preferred embodiment useful in smaller bodies of water, such as a spa, a Rule inline pump, model iL200p may be used or for slightly larger requirements, a Rile il500p pump may be used and for a larger body of water, such as a pool, a Rule 4000 pump may be used. Of course, any submersible pump may be used in connection with the principles of the present invention so long as it may be directly coupled with a filter without the use of hoses and long lengths of plumbing and so long as it can be simply placed directly into the body of water to be filtered and cleaned.

The filter 2 and pump housing 14 are preferably sized so that the filter outlet port 4 directly couples with the pump inlet 8. This coupling may be simply a frictional fit where the pump inlet 8 is inserted directly into the filter outlet port 4. The pump assembly 6 may also be coupled to the filter assembly 2 by or further supported using threaded or clip style couplings, connectors, male-female unions, adaptors, or other mechanical fasteners. Although an adhesive, glue or weld may be used, this could prevent ready cleaning or replacement of the filter assembly 2 and thus would need to be adapted for a one time use only or accommodate for cleaning or replacement of the filtration surface 3.

In an alternative embodiment, an adapter may be used to couple the pump 6 and filter 2. The adapter may be specifically configured to readily connect a filter assembly 2 to pump housing 14. The adapter may include a threaded section allowing it to be threaded to the filter inlet 4. Many readily available filters 2 are sold with various forms of adapters, including various forms of threaded ends. The pump housing 14 or inlet port 8 would then be adapted, for example, threaded or tapered, to mate with pump adapter to ensure a generally watertight coupling. Preferably, the filter 2 is removable for purposes of cleaning or replacement. Similarly, the pump 6 is preferably removable for cleaning and servicing as needed.

In another embodiment not shown, a pump 6 is coupled to filter outlet port 4 and another pump 6 is coupled to filter outlet port 5 so as to increase the flow and filtering rate. In this embodiment, a larger filter may be used to accommodate the passage of larger volumes of water.

The electrical cord 16 is secured to the pump 6. Because the pump 6 and filter assembly 2 are designed to be simply thrown (or gently placed) into a body of water for filtering, the electrical cord 16 must be designed for being submerged and for being pulled on as well as for resisting reasonable abrasion. A control cable may also be supplied for moving and retracting the pump and filter assembly 1 during use. In a preferred embodiment, the electrical cord 16 includes the control cable, which also may simply be coupled alongside the electrical cord itself. In this way, the pump and filter assembly 1 may simply be placed within the body of water and also removed using and having only one cord 16. The cord 16 may also then be used to control the location and depth of the pump and filter assembly 1 within the body of water being filtered. Alternatively, a battery powered pump, such as the ‘charge n flow’ by ITT Corporation may be used for smaller bodies of water and is preferably designed to hold a charge for sufficient time to filter the entire body of water. For larger bodies of water, a higher capacity pump should be used with a correspondingly larger battery or battery pack. In this embodiment, there is no power cord but a control cord or cable is preferable used.

The present embodiment of the invention may use a placement device or cleat for securing the control cable outside and preferably adjacent to the boy of water being filtered so as to control the placement of the pump and filter assembly 1 within the body of water. The cleat may include a boom, such as a telescoping boom to allow for placement of the pump and filter assembly 1 away from the side of the body of water and to facilitate moving and retracting.

Ballast may be added to the pump and filter assembly 1 to provide the proper buoyancy. In a preferred embodiment, the pump and filter assembly is slightly weighted over neutral buoyancy to ensure it stays submerged within the body of water yet is easily moved around and removed.

Preferably, the pump discharge 10 is left to discharge filtered water back into the pool, spa, fountain, well or other body of water being cleaned so. Direct discharge without the use of long hoses and plumbing reduces fluid drag, increases efficiency and allows for use of a much smaller and more efficient pump. The pump discharge port 10, however, may be adapted to facilitate coupling with a hose or other device for directing the flow of water. In one embodiment not shown, the discharge is directed along the bottom of the pool, spa or other body of water so as to stir up dirt and enhance the filtering.

In an alternative embodiment of the present invention, an adapter may be used to couple the filter assembly 2 with the pump 6. The adapter may couple directly with the filter 2 or even with a filter fitted with its own adapter. The adapter could be as simple as a coupling used to secure a pump assembly 6 that cannot be directly coupled to the filter assembly 2. The adapter, however, may be more complex, allowing for positioning of the pump to facilitate the configuration of the pump and filter assembly 1 to allow for filtering unique body of water configurations. The adapter may also be adapted to include a device for measuring pressure and to indicate when the filter 2 requires cleaning or replacement.

Referring now to FIG. 2, an alternative embodiment of the pump and filter assembly 20 is shown. In this embodiment, a filter assembly 22 is coupled to a submersible pump assembly 24 through fluid coupler 26. In the embodiment shown, the fluid coupler 26 is simply ABS pipe that directly couples to the filter 22 and pump 24. Preferably, the fluid coupler directly connects the pump 24 and filter 22 so as to eliminate or reduce fluid drag, turbulence, or other issues that increase pump requirements.

A base support 28 is adapted to allow the pump and filter assembly 20 to rest on the bottom or even the sides of the body of water being filtered while maintaining the filter 22 away from such bottom or sides. The base 28 may be provided in most any form that provides for a pump and filter assembly placed into a body of water to rest with the base on the bottom. The base 28 may also be fitted with wheels to facilitate moving the assembly 20 along the bottom or sides and may further include brushes. Preferably, the base support 28 is not fluidly coupled with the fluid coupler 26 so as to ensure the flow from the filter to the pump is as efficient and drag free as possible.

Electrical cord 30 provides for electrical power to the pump 24. A control cable (not shown) may also be provided for positioning and removing the pump and filter assembly 20 from the water being filtered.

Although the fluid coupler 26 and base 28 shown are made from readily available plastic pipe, they may preferably be made from a molded polymer such as a plastic. The fluid coupler may also be made from any type tube, pipe or fluid passageway that allows for the direct flow of water from the filter and out the pump. The actual size of the pump 24, filter 22 and fluid coupling 26 may be adapted to suit the particular size and type of body fluid to generally be filtered.

The base 28 may be adapted to provide the desired ballast or even to accommodate or modify such ballast. Preferably, the pump and filter assembly is slightly weighted so that is self positions on the bottom of the pool, spa or other body of water yet is sufficiently buoyant so as to be easy to move or remove. Ballast may include air pockets that can be filled with water, sand or other weight or emptied. As shown, the pump and filter assembly 20 provides a proper ballast. Alternatively, an end cap 33 may be removably connected to the base support 28 so it can be taken off to add or remove any such ballast

Pump 24, includes a discharge port 32. The discharge port 32 may be oriented as desired. As shown, the discharge port is oriented upwardly so as to move the clean water away from the bottom of the pool, spa or body of fluid being cleaning. In one preferred embodiment, the discharge port 32 is directly downwardly so as to stir up dirt and debris from the bottom of the pool and improve filtering as well as to aid in keeping the bottom generally cleaner. In another preferred embodiment, an inline pump is used with the discharge directed along the axis of flow.

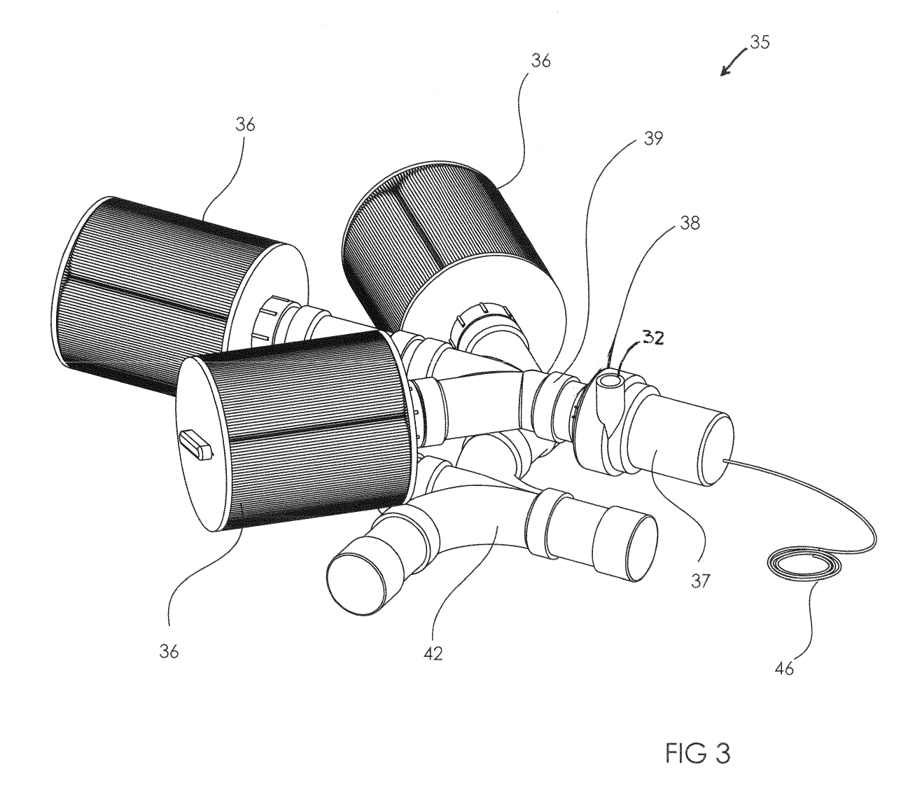

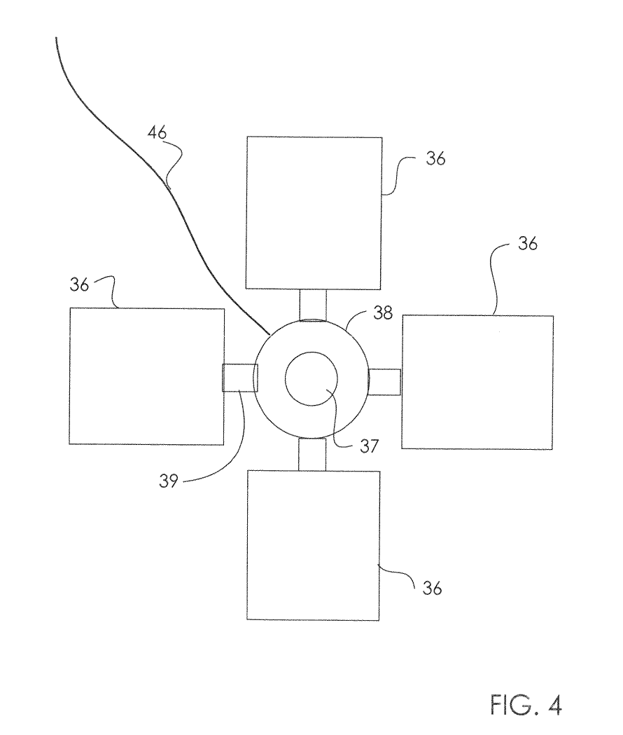

Referring now to FIGS. 3 and 4, an alternative embodiment of the pump and filter assembly 35 is shown. In this embodiment, multiple filter assemblies 36 are used to increase filtration capabilities. Although the illustrated pump and filter assembly 35 shows a plurality of spaced part identical filters 36, the assembly 35 may be fitted with various types and sizes of filters to accommodate different flows given each ones relative distance from the pump inlet 37 or for differing filtration characteristics. Moreover, a plurality of filters may be linked together using a coupler (not shown) at the secondary discharge 44 of each filter to fluidly couple the filters together. Similarly, most any number of filters 36 may be utilized so as to provide the maximum filtration with the minimum time between cleanings given appropriate pump 37 sizing to ensure adequate flow through the filters.

The multiple filters 36 of pump and filter assembly 35 allows for use in lager bodies of water such as large pools. An adapter 38 may be used to couple a larger volume pumping assembly 37, such as the 1800 gallon per hour pump by Rule as shown, to the fluid coupler 39 or filter assembly 35. Pipe clamps (not shown), such as stainless steel band type clamps, or similar devices may be used to secure the pump 37 to the adapter 38 at one end of the adapter and to the fluid coupler 39 on the other end. Electrical and control cord 46 extends from the pump and filter assembly 35 out to a power supply such as a conventional electrical outlet, with or without a transformer as needed to accommodate lower voltage direct current pumps. Alternatively the power cord 46 may extend to a remote power supply such as a green energy source.

Base 42 is used to balance the pump and filter assembly 35 and to elevate the filter off the bottom of the pool or other body of water being filtered. Similarly to other embodiments, the base 42 may include a ballasting system or device as well as wheels, brushes as well as a storage area for a retractable power and or control cable.

Referring now specifically to FIG. 4, the pump and filter assembly 35 is advantageously located centrally within a plurality of generally equally spaced apart filters 36. In this embodiment, the pump 36 draws equally from each filter assembly 36 to advantageously allow for only a single size filter. Moreover, this configuration advantageously allows for the maximum use of filters 36 with a single pump assembly 37. This configuration also advantageously balances the weight of the assembly 35 to simplify placement and removal within a body of dirty water.

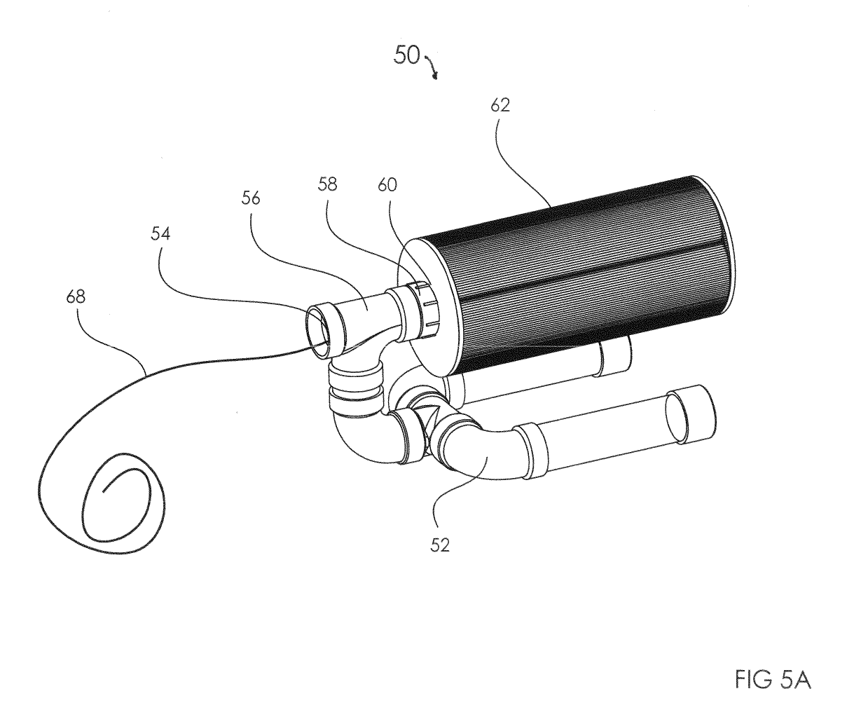

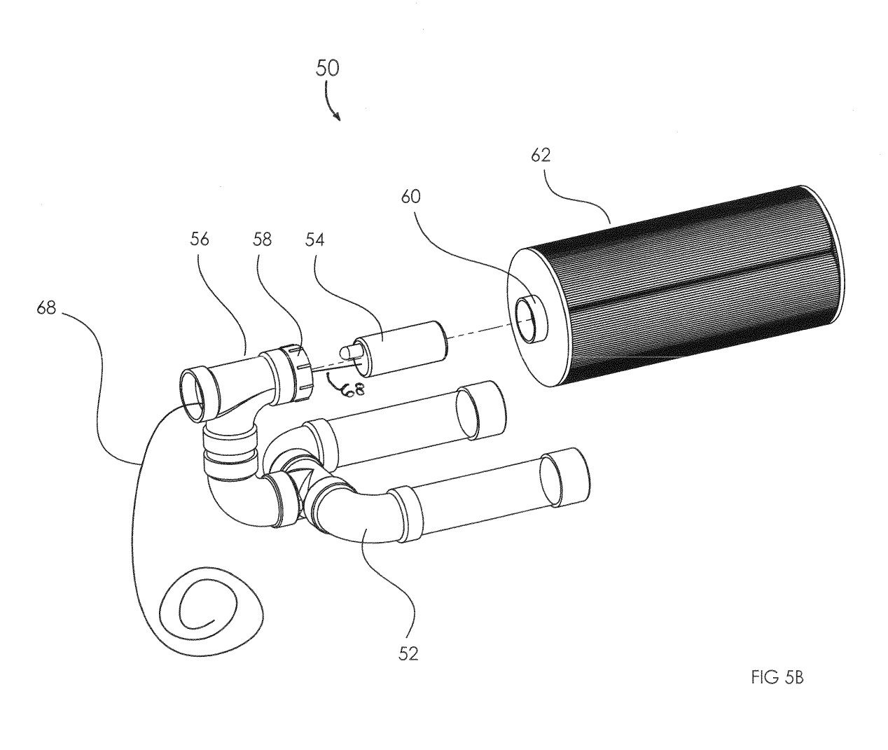

Referring now to FIGS. 5A and 5B, a pump and filter assembly 50 is shown having a base support 52 and utilizing an inline pump assembly 54. In this embodiment, the filtered water is moved along a straight flow path through fluid coupler 56 to maximize flow efficiency and thus, minimize energy requirements. Base support 52 is similarly connected to the fluid coupler 56 which fluidly connects the pump 54 with filter 62. In this embodiment, fluid coupler 56 includes a female threaded end 58 that is adapted to directly thread into the threaded outlet port 60 on the filter 62. Electrical and or control cord 68 extends outwardly for access outside the body of water.

The submersible pump used in the present invention may be any submersible pump cable of coupling with the described filter assembly. Preferably the pump will include a direct current elect motor such as a 6 to 12 volt direct current motor or alternatively a 24 volt motor. Generally the longer the run to the power source or the larger the pump motor, the higher the preferred dc voltage. Low voltage dc power is advantageous for safety reasons. The low voltage power supply may come from a converted 110 volt household ac supply or from any variety of alternative and green power supplies. Generally, a brushless motor is preferred for the pumps of the present invention because of its energy efficiency and quiet operation though any type of submersible capable pump may be adequate.

The filter of the present invention should be capable of full immersion into the body of water to be cleaned. Preferably having a surface filtration method such as a paper, spun plastic and or screen filter media and having a generally thin filter medium to reduce flow and pressure drop across the media. As noted such filters are readily available and may be acquired from Pleatco, in New York, which include the preferred spun polyester pleated media. Various filtration media may be selected based on the cleaning desired. In one embodiment, the filter or filters may be provided with a cover (not shown). The filter may be fitted over the filter and couple to the base or the fluid coupler or may even be provided as part of the filter assembly. The filter cover preferably includes ports, grate or other openings to ensure full flow of water to the filter while providing some restriction to debris that could clog or damage the filter. The filter cover may be provided as a unique aesthetic piece to simply make the filter look better. In one form, the filter cover may be provided in the shape of a shark, whale, dolphin or other animal. The filter cover could also be removable so as to allow easy access to the filter or to interchange with a different style cover.

Electrical power may be supplied to the pump of the present invention through a power cable. Because of the high efficiency of the present system and the low required direct current power draw, particularly for systems designed for smaller bodies of water, an internal battery supply may simply be used. Alternatively, the pump and filter assembly may include a battery supply and also be adapter to connect with a green energy supply such as a solar panel as further disclosed below or even a wind turbine.

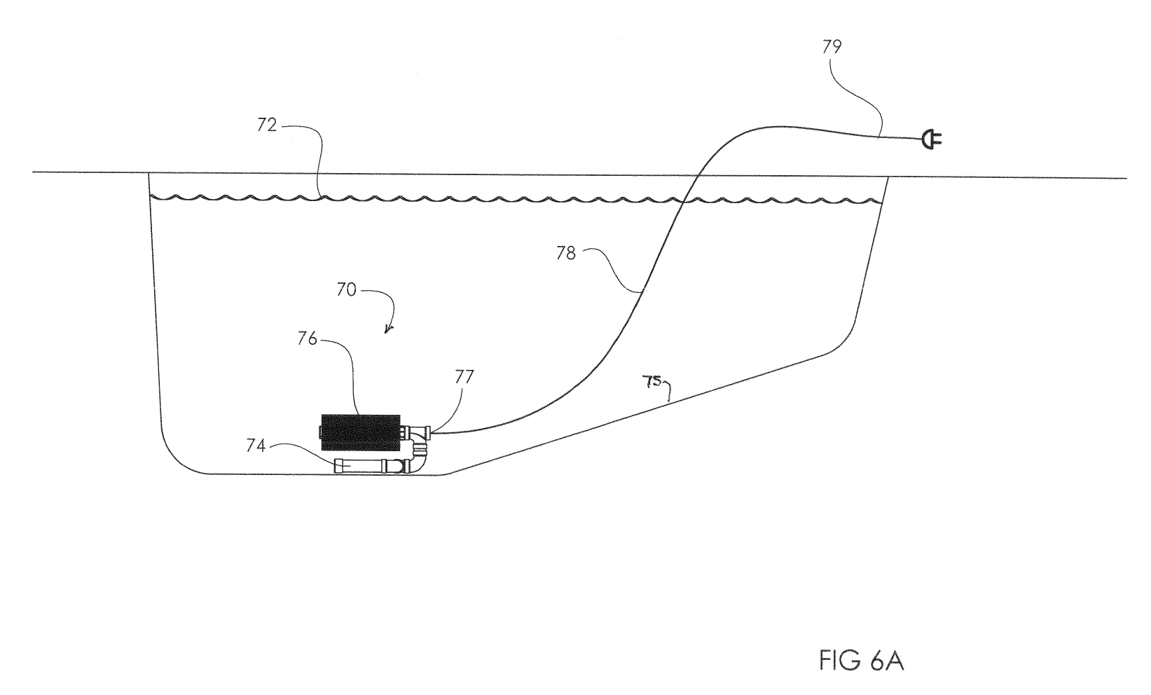

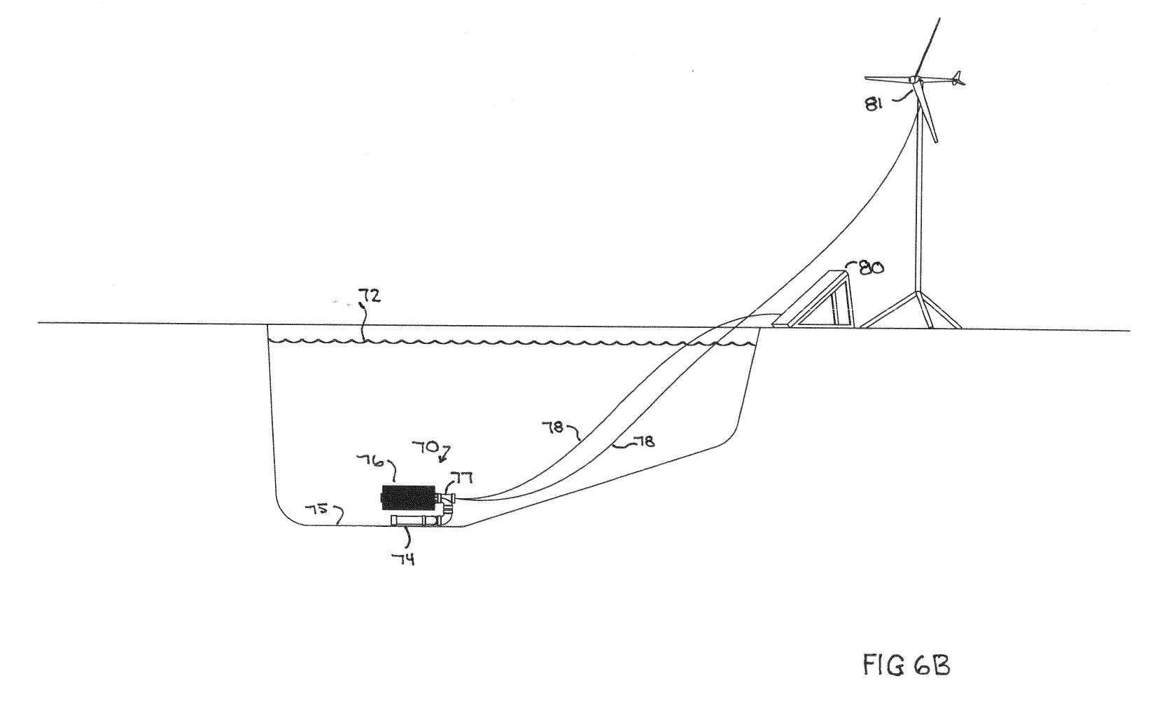

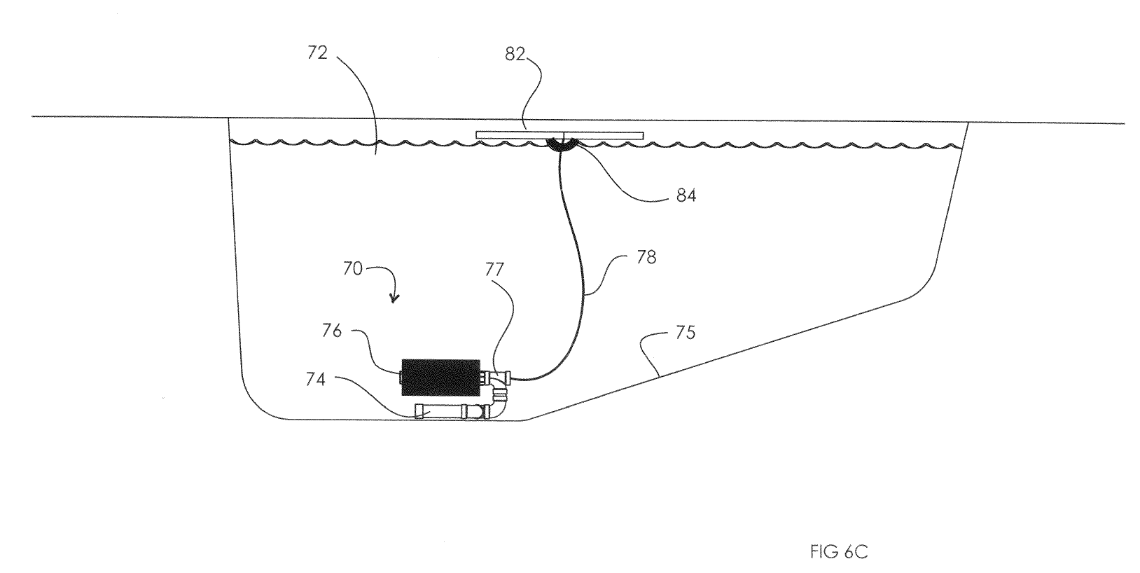

Referring now to FIGS. 6A, 6B, and 6C, an embodiment of present invention is illustrated using a variety of different power sources. Referring now specifically to FIG. 6A, the pump and filter assembly 70 is shown submerged in a conventional swimming pool 72. The pump and filter assembly 70 is placed within the pool water and allowed to sink where the base support 74 settles on the bottom 75 of the pool. In this position, the filter assembly 76 is maintained adjacent but above the bottom 75 so as to avoid being clogged by leaves and debris that may collect on the bottom. Pump 77 draws water through the filter 76 and discharges the filtered water back into the pool away from the filter. The pump 77 is powered through electrical cord 78 that extends out of the pool 72. In this embodiment, the electrical cord adapted with a plug 79 to connect to a conventional 110 volt alternating current outlet. Preferably, the 110 volt ac power is converted to low voltage dc power such as 12 volts dc and such conversion may be done via a transformer at or near the plug 79. Alternatively, the pump 77 may include a 110 volt motor. Although the pump and filter assembly 70 is shown at the bottom 75 of the pool 72, it may be positioned at any depth or along the sides using cable 78 or an alternative control cable (not shown).

Referring now specifically to FIG. 6B, the pump and filter assembly 70 is again shown submerged in a conventional swimming pool 72. In this embodiment, the pump 77 is powered through electrical cord 78 that extends out of the pool 72 and is coupled to a green power source such as a solar panel 80 or a wind turbine, either of which may also include a battery or other electrical energy storage means. Although the present embodiment is shown having multiple power cords 78 and power sources, in the preferred embodiment, there would only be one power cord 78 and preferably only a single type of electrical power supply.

Referring now specifically to FIG. 6C, the pump and filter assembly 70 is again shown submerged in a conventional swimming pool 72. In this embodiment, the pump 77 is powered through electrical cord 78 that remains within the pool water 72. The electrical cord is coupled to a floating solar panel 82. The solar panel 82 may include a control cable device 84 for adjusting the depth of the pump and filter assembly 70. Alternatively, device 84 may include the electronics necessary to convert the solar power to the power required by the pump 77. The solar panel may be further fitted with an on off switch for the pump and filter assembly 70 or even a filter change status indicator. Depending on the size of the pump 77, the preferred solar panel should be sized to produce from a minimum of about 15 watts to over 300 watts of low voltage direct current power.

In this embodiment, there is advantageously no electrical cord extending outside of the pool though the assembly 70 or alternatively the solar panel 82 may be fitted with a control cable (not shown) to facilitate positioning and removal of the pump and filter assembly. Such a control cable may be coupled to a removable cleat secured adjacent the side of pool 72. The control cable may comprise a cable, rope, string or even hose or anything to facilitate placement and removal of the assembly 70 and may be retractable. The control cable may also be semi rigid to maintain positioning of the pump and filter assembly 70.

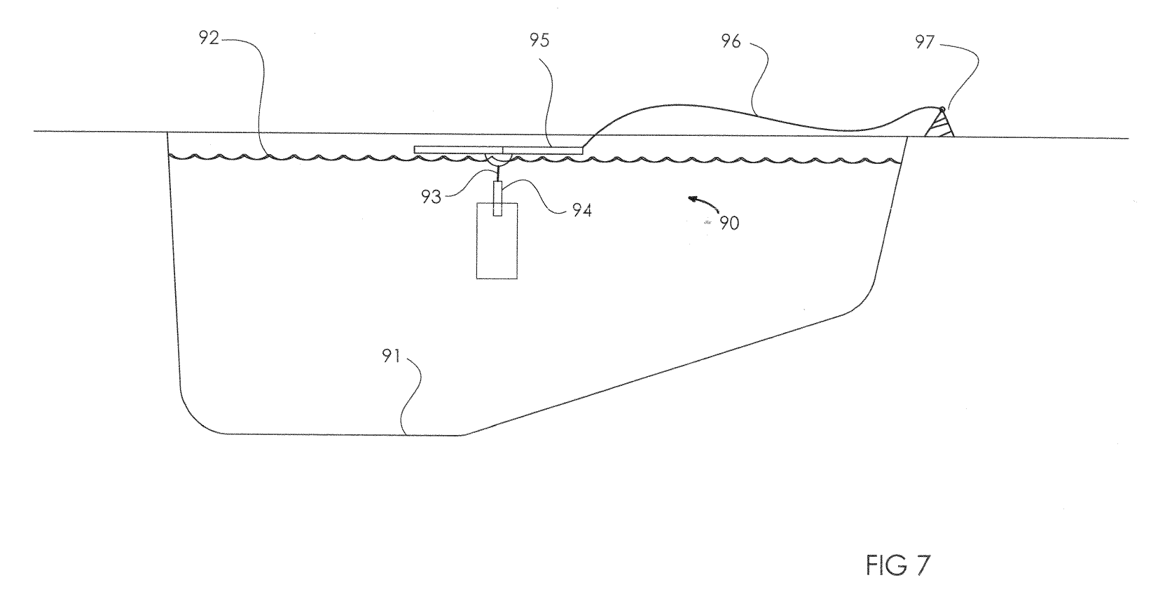

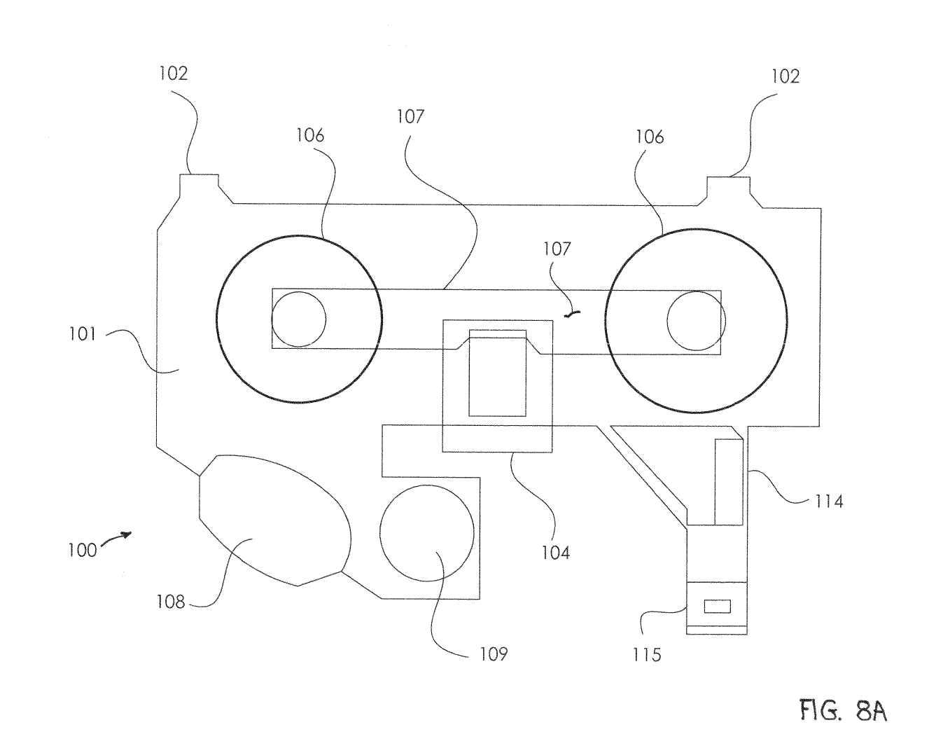

Referring now to FIG. 7, an embodiment of the present invention is shown submerged within a pool and elevated above pool bottom. Specifically, pump and filter assembly 90 is suspended above the bottom 91 of pool 92. Cord 93 electrically connects the pump 94 to a solar panel 95. In a preferred embodiment as shown, the solar panel is a floating solar panel 95 that generates direct current for use by the pump 94. Cord 93 may be adjustable and may be retractable to allow positioning of the pump and filter assembly 90 at various depths within the pool 92. A control cable 96 may be coupled to a control base 97 that is removeably secured along the side of the pool to facilitate placement and removal of the pump and filter assembly 90 as well as position the solar panel 95 for maximum energy grab.

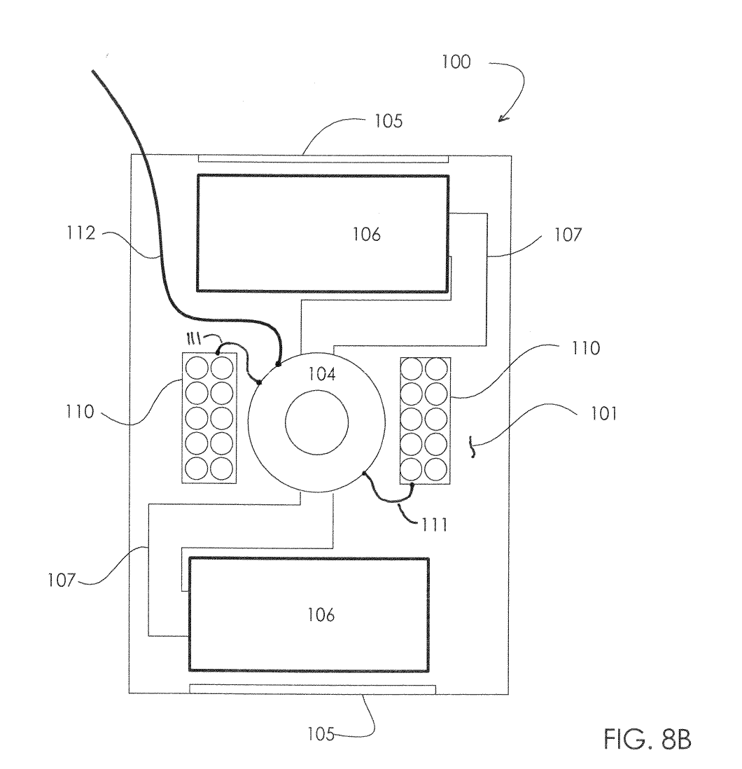

Referring now to FIGS. 8A and 8B, a pump and filter assembly 100 is shown having a housing 101 with support members 102 and utilizing a pump assembly 104 supported within the housing. In this embodiment, the water being cleaned is moved into the housing through openings 105 or grates within the housing 101 that allows the water to flow onto the filter 106. The pump 104 draws the water through fluid connectors or plumbing into the pump inlet where it is discharged back into the body of water being cleaned. A light 108 may be provided. A tab dispenser 109 may also be provided to allow for the dispensing of chemicals. In a preferred embodiment of the pump and filter assembly 100 with a tab dispenser 109, the tab dispenser is adapter to hold standard pool sized chlorine based tablets for dissolving in the water such as 3 inch diameter. Other embodiments may, however, provide for alternative chemical dispensing.

Referring now specifically to FIG. 8B, the pump and filter assembly 100 includes a battery 110. As shown, a pair of rechargeable direct current batteries 110 are spaced apart from the pump assembly 104 in a balanced configuration. The batteries are directly coupled to the pump 104 though battery cables 111 and are preferably designed to provide sufficient charge to allow for a complete cleaning of the desired body of water. Sizing of the batteries 110 as well as the number of batteries may be based on the pump 104. In a preferred embodiment, the batteries 110 may each be 12 volt and about 10 amp direct current batteries. The batteries 110, however, may also be lower voltages such as 6 volt or even higher voltages such as 24 volt depending on the application and method of charging as is known in the art. The batteries 110 may be charged through a charging port (not shown) when the assembly 100 is removed from the water. The batteries 110 may also be adapted to be removed from the housing 101 for charging.

Electrical and control cord 112 is coupled to the pump 104 and may also be coupled to the housing 101. Alternatively, a separate safety cord and float (not shown) may be provided to facilitate retrieval, repositioning and removal. The electrical cord 112 preferably extends to a power source capable of powering the pump 104 or alternatively charging the batteries 104. In a preferred embodiment, the power and control cable 112 is directly coupled with a floating solar panel (not shown) for recharging the batteries 110.

Referring now back to FIG. 8A, the pump and filter assembly 100 may include a water motion sensor 114 to sense water motion such as a child or animal entering the body of water. The water sensor 114 is coupled to an alarm outside the pool. In a preferred embodiment the housing 101 is adapted to support the water motion sensor such as a sensor provided by Smart Pools and is coupled to an alarm through the electrical cable 112. An electrical and control cord 112 support 115 may be integrated as part of the housing 101 or a separate attachment. The cable support 115 is preferably located at a balancing point so as to not obstruct water flow but to facilitate placement and removal of the pump and filter assembly 100.

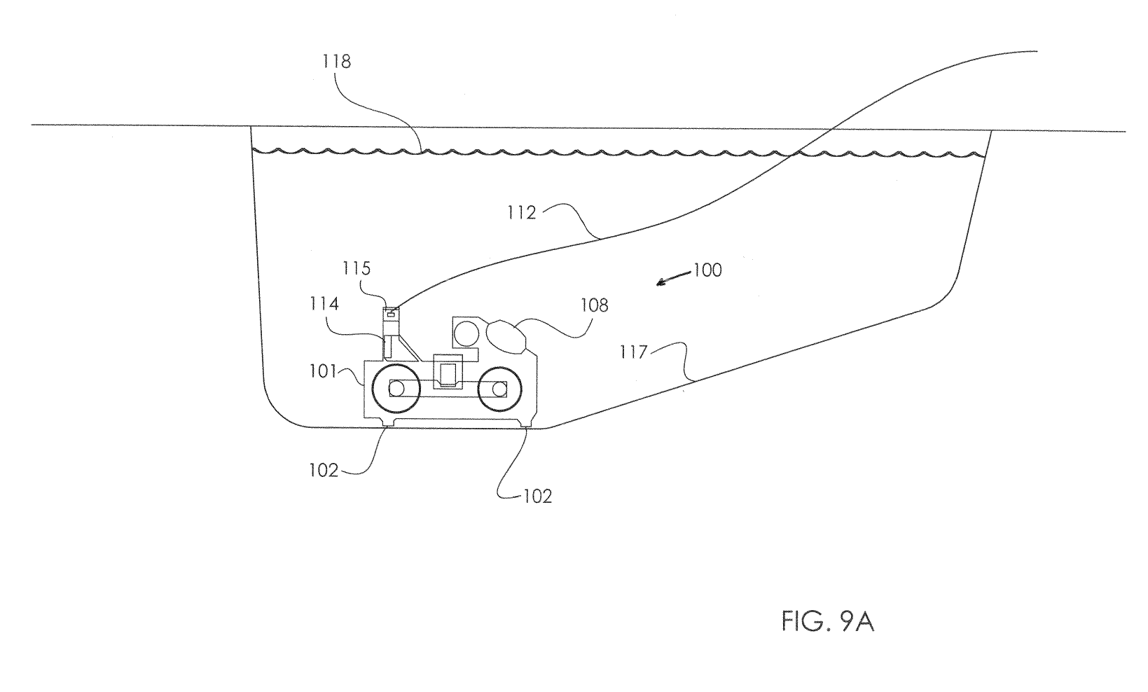

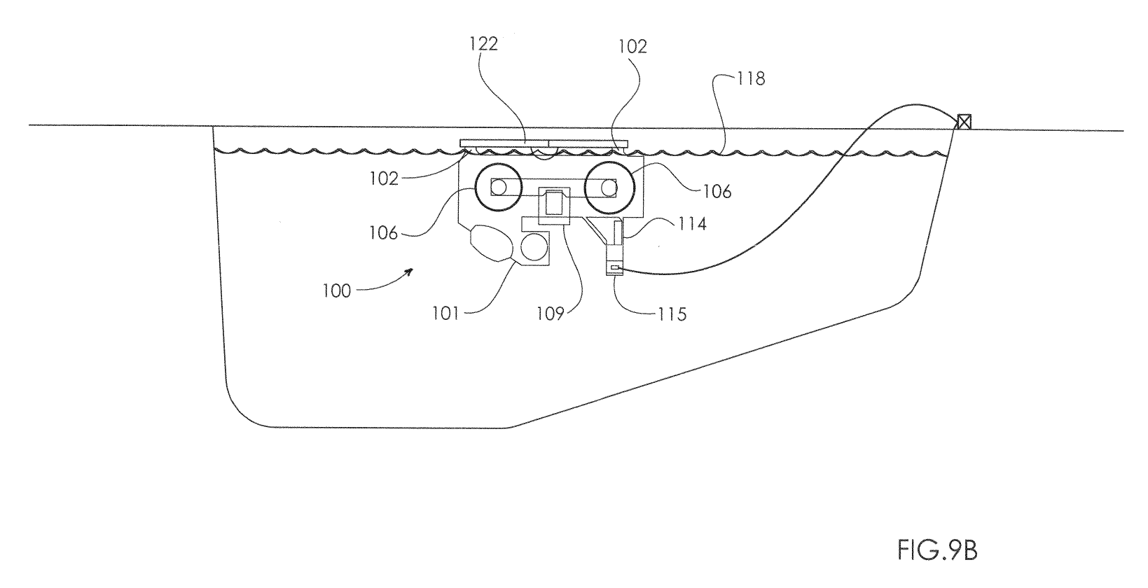

Referring now to FIG. 9A in conjunction with the embodiment shown in FIGS. 8A and 8B, the pump and filter assembly 100 is shown located on the bottom 117 of a pool 118. Base supports 102 extending from the housing 101 support the pump and filter assembly just off the bottom 117. The light 108 is oriented to allow easy identification of the pump and filter assembly 100 or for aesthetic purposes. Electrical and control cable 112 extends outwardly from the cable support 115 to a power source (not shown). The electrical and control cable 112 may also couple an alarm (not shown) with the water motion sensor 114 as well as the housing 101 with an emergency retrieval cord.

Referring now to FIG. 9B in conjunction with the embodiment shown in FIGS. 8A and 8B, the pump and filter assembly 100 is shown suspended within a pool 118. The base support members 102 are connected to a float 120, which may include solar panels 122. The solar panels 122 may be oriented so as to collect the maximum sunlight. The solar panels 122 are directly wired to the pump 104 and avoid the need for any electrical cord. An alarm may also be provided on the float 120 and coupled to the motion sensor 114. Control cord 122 connects the cable support 115 at the housing 101 with the pool or alternatively may be coupled to a float. In this embodiment, the filters 106 are maintained just below the surface of the pool 118.

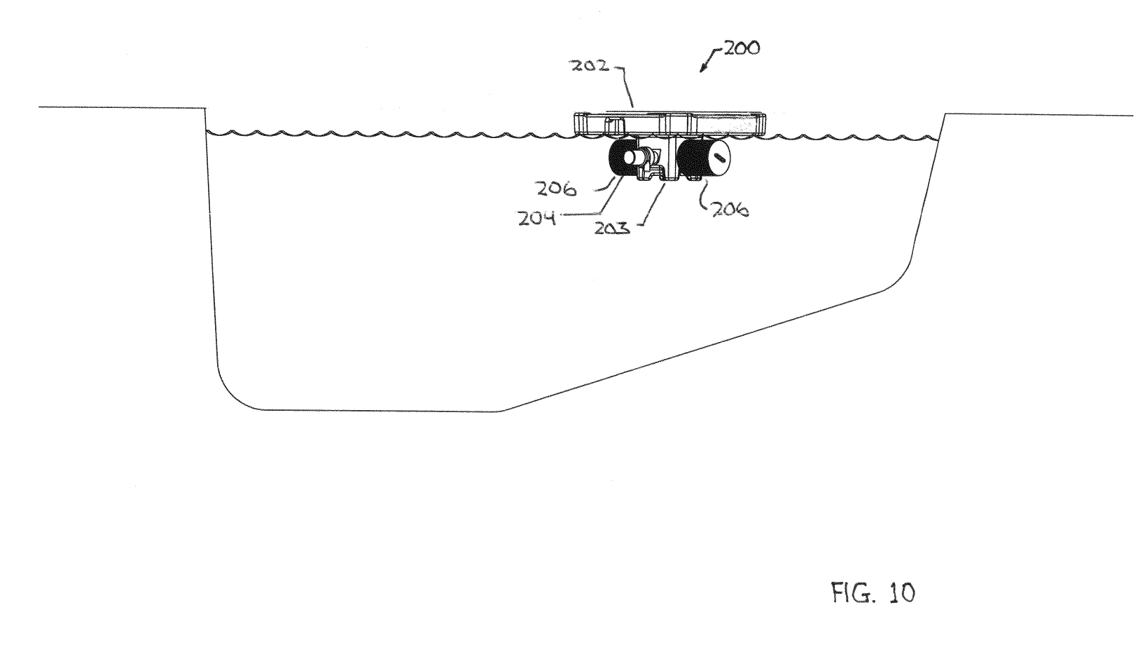

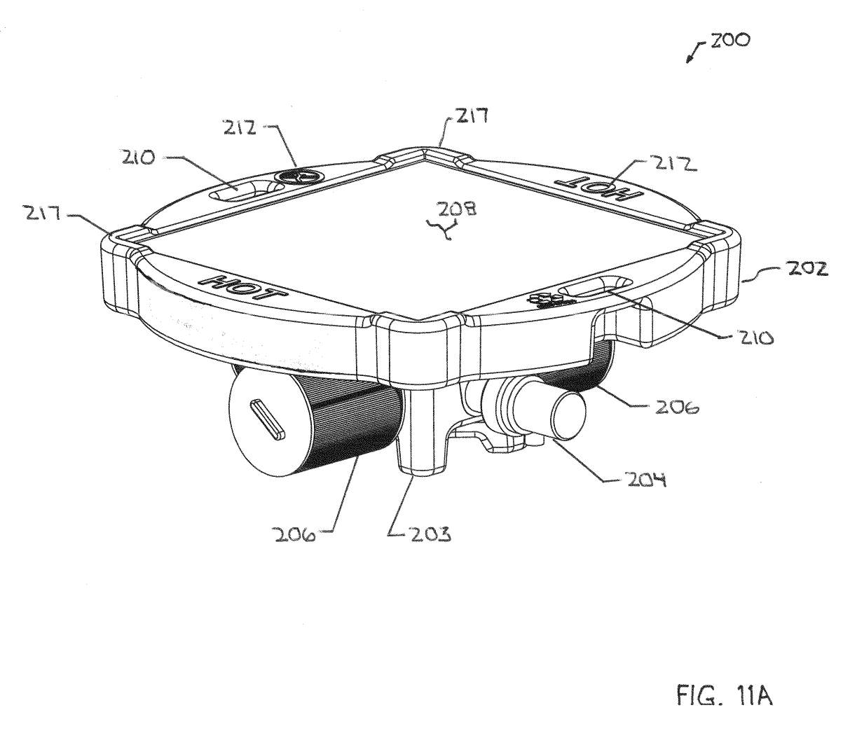

Referring now to FIG. 10 a preferred embodiment of the present invention provides a self-contained pump and filter assembly 200 shown placed in an operating position within a swimming pool. The pump and filter assembly 200 includes a float 202 that is adapted to generally float on the surface of the water or water based fluid being filtered while supporting the filtering means. The float 202 preferably includes a manifold assembly 203 for fluidly connecting at least one pump 204 with a filter 206. The manifold may also support the pump assembly 204 In the embodiment shown, the single pump is used to move water through three filters 204.

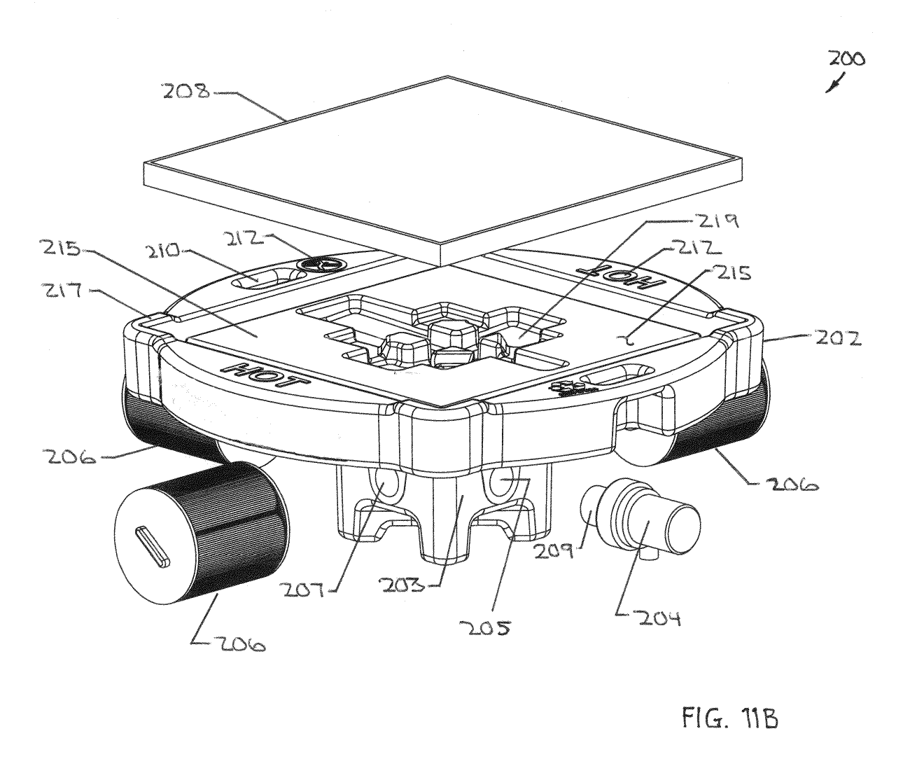

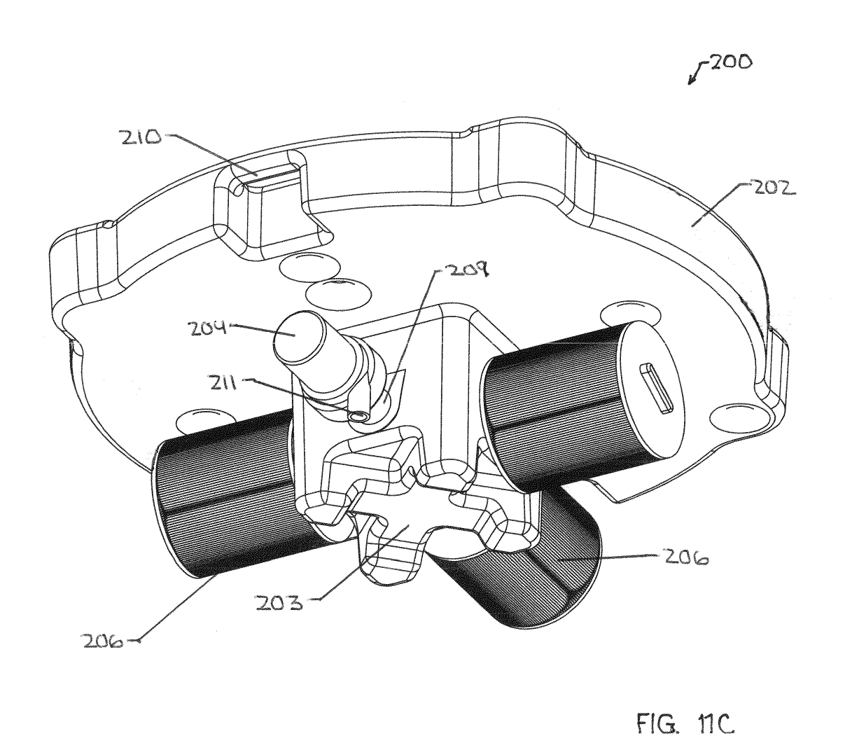

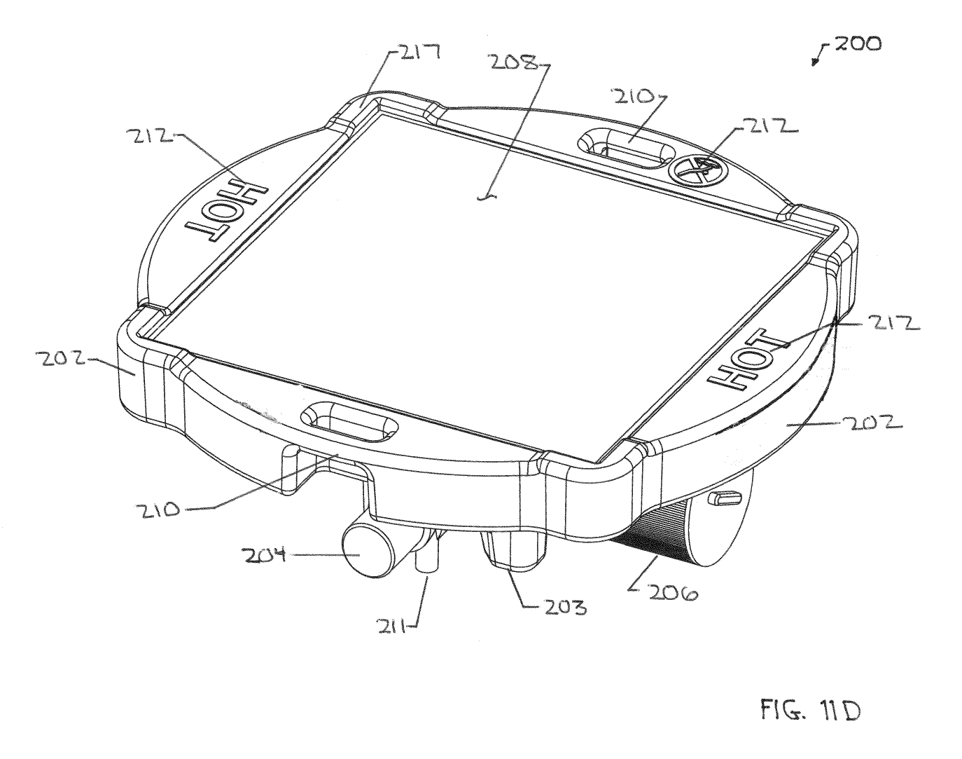

Referring now to FIGS. 11A through 11D, the pump and filter assembly 200 of FIG. 10 is described in greater detail. The pump and filter assembly 200 includes the float 202 adapted for supporting the assembly on the surface of the fluid to be filtered. The float 202 is further adapted to support a solar panel 208 facing upwardly. As shown, the solar panel 208 is preferably slightly inset below the upper surface 217 of the float 202. As shown, the solar panel 208 is supported facing straight up but the invention contemplates also orienting or angling the panel to take maximum advantage of available solar energy. The float 202 may include handles 210 and even markings 212.

The float 202 and manifold 203 are preferably made from a plastic and may be made using a roto molding process. Such plastics are available from many roto molder suppliers such as from Exon Chemical. One advantage of the present invention is the ability to manufacture the float 202 and manifold assembly 203 in varying shapes, sizes and colors. The float 202 and manifold 203 may also be made using other known methods such as blow molding or from other materials such a fiberglass. The float 202 may be constructed as a generally hollow shell or alternatively may include a foam filler to prevent water intrusion to the detriment of floatation.

Filter 206, or in the embodiment shown, filter, are directly coupled to the manifold 203, which provides a fluid coupling or passageway to the pump 204. Preferably, the pump 204 is mechanically and fluidly connected and coupled to a pump port 205 on the manifold using an adapter 209 such as a threaded adapter. The threaded adapter may be pressed into the manifold is inserted into each port 205 of the manifold 203 for connection with float assembly. Filter 206 or filters 206 may be coupled to the manifold 203 using a male to male connector or union or even through an adapter.

Pump 204 include a pump outlet 211 where the filtered fluid is discharged back into the unfiltered fluid. As previously noted, a hose or other plumbing may be connected to this outlet port 211 to direct the flow of the filtered fluid. The pump outlet 211 may also be adapted to provide a drive means for the pump and filter assembly 200. For example, the outlet 211 may be directed so the discharge force pushes the pump and filter assembly in a large circle or other patter. Alternatively, the outlet port 211 may be fitted with a nozzle or other adapter for directing the cleaning path of the pump and filter assembly 200.

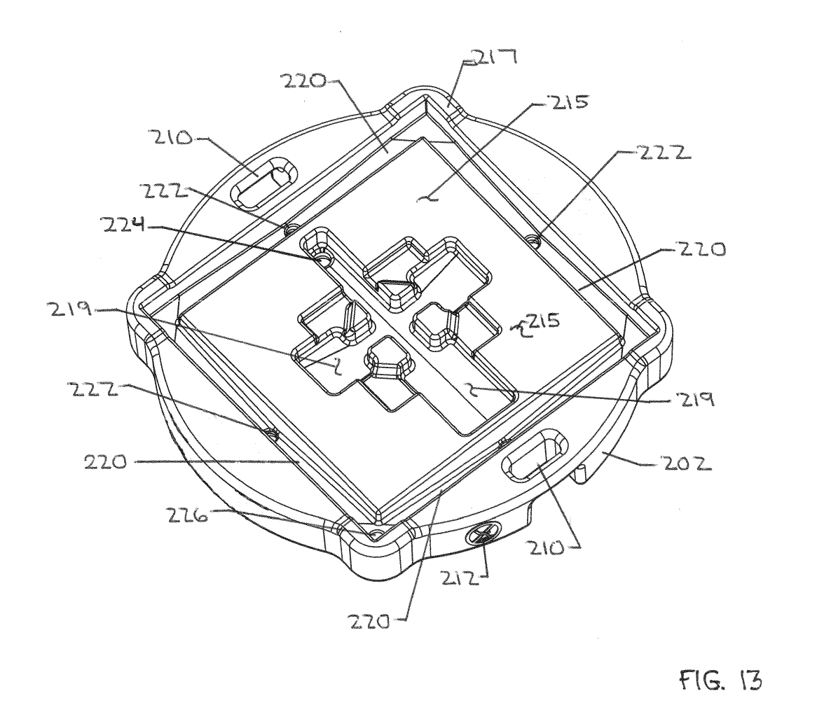

Solar panel 208 is preferably inserted directly into the upper surface of the float 202. As best shown in FIG. 11B and FIG. 13, the float 202 may be advantageously formed with an inset portion 215 that is adapted to support and even retain the solar panel 208. Preferably the solar panel 208 is held within the inset portion 215 of float 202 through a friction tight fit. Alternatively or in conjunction with a friction fit, an adhesive or mechanical retainer may be used. As noted, the inset portion 215 is preferably deeper than the thickness of the solar panel 208 and adapted so the panel is not damaged if the assembly 200 is placed upside down. In a preferred embodiment, the solar panel is inset approximately ¼ inch below the upper surface 217 of the float 202

The inset portion 215 of the float 202 may be further inset and include an inner housing area 219 that is adapted to support and retain the associated charge controller electronics of the solar panel 208 along with any battery provided to store power as well as provide a passageway for the electrical connection to the pump 204. The inset portion 215 may further be used to support and generally house any other included electronics such as sensors for pump and filter status, water temperature or other information as well as a wireless system for making such information available to an associated wireless monitoring system (not shown).

Solar Panel 208 is preferably sized and adapted to provide sufficient power to operate the pump 204 and any other included electronics such as any included sensors and associated wireless sending unit. Thus, the solar panel 208 should be sized to ensure enough power to run the provided pump 6 or pumps sufficient to filter the water as desired. In one preferred embodiment, the solar panel is a 55 watt marine grade solar panel, such as the 55 W 12V marine solar power kit provided by UL-Solar or Las Vegas, Nev. This panel is approximately 25.2 inches by 25.7 inches and generally matches the dimensions of the inset portion 215 of the float 202. In alternative embodiments, both larger and smaller, different power and sized panels 208 may be used. Alternatively, custom sized panels may be used as well as lightweight versions as they become more readily available and affordable. Of course, the larger solar panels 208 will preferably be fit with a larger float 202.

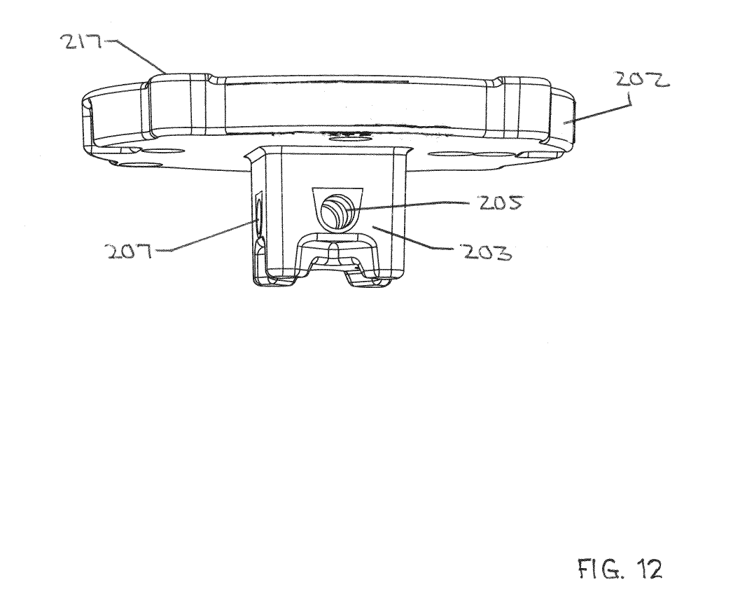

Referring now to FIG. 12, float 202 and manifold 203 are shown as one piece integral roto molded or blow molded unit. The manifold 203, however, may be a separate component that is simply attached to the float 202 as is well known in the art of plastics and materials. Manifold 203 includes at least one openings or port 205 for supporting pump 204 and at least one other port 207 for coupling with the filter 206. Preferably, the manifold 203 includes 4 to 6 ports 205 and 207 for use with at least one pump 204 and one or more filters 206. Ports 205 or 207 that are not used are simply closed using a plug, cap or other means. In the smaller pump and filter assembly 200, only one pump 204 and one filter 206 may be preferable, while in a larger unit, a larger or multiple pumps 204 may be used with a filter 206 in a plurality of filter ports 207. Manifold 203 may be advantageously configured with base members or feet for supporting the pump and filter assembly 200 while dry docked or otherwise out of the pool or other body of water. Alternatively, these base members 203 may be used to store various other desired electronics such as a receiver for a remote control system or an alarm system.

Referring now to FIG. 13, the upper surface of a preferred embodiment of float 202 is shown. In the preferred embodiment shown, the float 202 is adapted to provide substantial floatation above the ballast needed to support and float the solar panel, electronics, pump, filters and all assemblies while maintaining approximately 1 to 4 inches of the float above the surface of the water. In this configuration, the float may advantageously act as a safety float in the event someone or something falls into the water. Handles 210 may be used to insert, move and remove the pump and filter assembly 200 and may be integrally formed as part of the float 202 or attached using methods and means well known. Similarly, markings 212 may be integrally formed as part of the float 202 or added later. Such markings 212 may provide instructions, cautions or other information.

Preferably, the inset portion 215 of the Float 202 includes channels 220 that are adapted to drain water away from the solar panel and to drain ports 222 and back to the pool or other water being filtered. The further inset portion 219 is similarly adapted such that it drains water to a drain port 224 located at the lowest level of the inset. Preferably, the drain ports 222 and drain port 224 are maintained just above the surface of the water to facilitate drainage. Drain port 224 may also be further adapted to allow for power from the solar panel to couple with the pump.

A solar panel release port 226 may be provided to facilitate removal of the solar panel and access to the electronics supported within the inset portion 219. Once all connections connecting the solar panel to the float 202 are removed, a user can lightly push on the solar panel through the release port 226 and pop the panel out of the float.

Referring now back to FIG. 10, the float 202 is preferably adapted to maintain the solar panel 208 and electronics above the surface of the water. Even though the electronics are preferably watertight, included sealed connections and potted electronics, the preferred design maintains the electronic components, except the pump 204 from being submerged. The currently preferred pump and filter assembly 200 provides approximately 1 to 4 inches of float 202 above the surface of the water being filtered.

Applicant notes that the present invention provides for a significant saving in energy costs over conventional pool, spa and related water filtration systems. This savings is above and beyond the savings obtaining in initially purchasing the present pump and filter system over existing filtration systems. Applicant estimates, based on the total electrical consumption of the present invention over existing convention pool and spa pump and filters systems, that use of the present invention could reduce overall energy consumption in connection with filtering pool, spa and related bodies of water by well over one half of existing usage.

The foregoing description of the embodiments of the invention has been presented for the purposes of illustration and description. It is not intended to be exhaustive or to limit the invention to the precise forms or methods disclosed. Persons skilled in the relevant art can appreciate that many modifications and variations are possible in light of the above teaching.

1. A portable water filtering assembly for filtering a body of water comprising:
a water filter having an exterior filtration inlet surface and a filter outlet port, said filter adapted to filter water passing through the filtration surface and out through the filter outlet port;
a submersible fluid pump having an inlet and a discharge, said pump inlet directly connected to the filter outlet port and adapted to move water from the filtration surface and out through the pump discharge; and
an electrical connection for electrically coupling the pump to a power source;
wherein the water filtering assembly is adapted to be submerged within the body of water at various depths.

2. The submersible filter assembly of claim 1 wherein the pump is an inline pump having the pump inlet and outlet aligned along a common axis.

3. The submersible filter assembly of claim 1 wherein an adapter is used to directly connect and fluidly couple the pump with the filter.

4. The submersible filter assembly of claim 1 further comprising a solar panel assembly adapted to float on the body of water and provide power to the pump, said solar panel assembly electrically coupled to said electrical connection and adapted to support the pump and filter within the body of water.

5. The submersible pump of claim 1 wherein the filter is removably coupled to the adapter.

6. A portable filtering apparatus for filtering open bodies of water comprising:
a filter having an exterior filtration surface and a filter outlet port, said filter adapted to filter water passing through the filtration surface and out through the filter outlet port;
a submersible fluid pump having an inlet port and a discharge, said inlet port connected to the filter outlet port and adapted to move water from the filtration surface and out through the pump discharge;
a tubular frame assembly adapted to support the pump and filter assembly and fluidly connecting the filter outlet to the pump inlet; and
an electrical connection for electrically coupling the pump to a source of electrical power for powering the pump;
wherein the tubular frame assembly is adapted to support and balance the pump and filter assembly both in operation and when outside of any body of water.

7. The pump and filter assembly of claim 6 further comprising:
a second filter spaced apart from the first filter, said second filter also fluidly is coupled to the pump;
wherein at least a portion of the tubular frame fluidly couples the outlet port of each filters to the inlet of the pump.

8. The pump and filter assembly of claim 7 wherein the pump is centrally located between a plurality of spaced apart filters and wherein at least a portion of the tubular frame assembly fluidly connects each filter with the pump.

9. The submersible pump assembly of claim 8 further comprising a float assembly having a pump and filter assembly positioning device adapted for positioning the pump and filter assembly at a plurality of depths within the body of water.

10. The pump and filter assembly of claim 8 wherein the power supply is a solar panel that is electrically connected to the pump through an electrical cable.

11. The pump and filter assembly of claim 8 wherein the power supply is a solar panel assembly adapted to float on the water being filtered.

12. The pump and filter assembly of claim 8 further comprising a wireless status notification device adapted to provide status information on the pump and filter assembly.

13. A portable pump and filter assembly for filtering a body of water comprising:
a filter having an exterior filtering surface inlet and a filter outlet, said filter adapted to filter water passing through the filtration surface and out through the filter outlet;
a submersible electric pump having an inlet port and a discharge, said pump adapted to move water through the filtering surface and out through the pump discharge;
a manifold for fluidly coupling the filter outlet and the pump inlet;
a solar panel electrically coupled to the pump and adapted for providing power to the pump; and
a float assembly connected to said manifold and adapted to support the solar panel,
wherein the float is adapted to float on the water and support the solar panel above the water while maintaining the manifold within the water.

14. The pump and filter assembly of claim 13, wherein the manifold is adapted to connect to and support each of the pump and filter.

15. The pump and filter assembly of claim 14, wherein the float and manifold assembly further comprises a one piece assembly formed with drain channels to drain water away from the solar panel and back into the body of water.

16. The pump and filter assembly of claim 14, further comprising a battery that is electrically coupled to the solar panel and pump and wherein the float is further adapted to support and maintain the battery above the body of water.

17. The pump and filter assembly of claim 15, wherein the filter is a plurality of filters and each filter is independently coupled to the manifold and the manifold is further adapted to fluidly connect the pump with each of the filters.

18. The pump and filter assembly of claim 15, wherein the manifold further comprises a base portion adapted to support the pump and filter assembly when removed from the body of water.

19. The pump and filter assembly of claim 15, wherein the pump and each filter is spaced apart about the manifold.

20. The pump and filter assembly of claim 15, further comprising a wireless monitoring system.
